(19) United States
(12) Patent Application Publication
(10) Pub. No.: US 2026/0195704 A1
(43) Pub. Date: Jul. 9, 2026

(54) SYSTEM AND METHOD OF ORCHESTRATION BETWEEN HETEROGENOUS ROBOTS AND ROBOTS FROM MULTIPLE ROBOTIC PLATFORMS FOR ITEM DELIVERY

(71) Applicant: NEOM Company, Riyadh (SA)

(72) Inventor: Alessio GAROFALO, Dubai (AE)

(21) Appl. No.: 19/129,276

(22) PCT Filed: Nov. 14, 2023
(86) PCT No.: PCT/IB2023/061498

§ 371 Date: May 12, 2025

(30) Foreign Application Priority Data
Nov. 14, 2022 (GB) 2216978.3

(51) Int. Cl. G06Q 10/083; G05D 1/246; G05D 1/667; G05D 1/69; G05D 105/20; G05D 109/10; G05D 111/30

(52) U.S. Cl. CPC G06Q 10/0843; G05D 1/246; G05D 1/667; G05D 1/69; G05D 2105/20; G05D 2109/10; G05D 2111/32

(57) ABSTRACT

A delivery system for automatically delivering items from a source location to a destination location within a delivery environment is described. The system comprises: a plurality of remotely operable heterogeneous robots, and an orchestration system configured to control and orchestrate the plurality of heterogeneous robots to execute the delivery of items from the source location to the destination location. The orchestration system comprises: an upstream communications engine for communication with a plurality of different service request platforms, the upstream communications engine being configured to receive a delivery request for the delivery and to transmit data relating to the status of the request as the request is processed; an orchestration logic engine configured to process the delivery request and select and instruct the plurality of heterogeneous robots to execute the delivery of the items from the source location to the destination location specified in the delivery request, each robot handling a unique part of the delivery and the concatenation of the unique parts forming the delivery from the source location to the destination location, the orchestration logic engine comprising a digital twin model for providing a 3D (3-Dimensional) map of the delivery environment in which the plurality of heterogeneous robots are operating, and being configured to constantly update the digital twin model with data received from the plurality of robots executing operations within the delivery environment; and a downstream communications engine for communicating with the plurality of heterogeneous robots either directly or via a plurality of different robotics control platforms each controlling a subset of the plurality of heterogeneous robots, the communications engine providing a communications gateway for receiving and transmitting data between the orchestration system and the plurality of heterogeneous robots, in use, the communications gateway being configured to convert messages between a first domain of the orchestration system and a different domain of each of the subsets of the plurality of heterogeneous robots to provide downstream interoperability.

### TECHNICAL FIELD

The present description generally relates to the technical field of robotic orchestration, and relates in particular, though not specifically, to a system for automatically delivery of items to customers from one location to another by orchestrating multiple types of autonomous robots. Such automated delivery of items is particularly problematic over the last mile of a delivery journey, where the variability of the different environments through which items need to be transported is very challenging for robots. Robotic orchestration is generally considered to be the control of multiple heterogeneous robots to achieve a specific task.

### BACKGROUND

With the development of e-commerce, last-mile delivery has become a significant part of a customer's shopping experience and robot-based autonomous delivery is gaining popularity. Therefore, the concept of an autonomous last-mile delivery method using multiple types of robots as a smart logistics service provides a promising solution to reduce delivery cost, improve efficiency, and avoid the spread of airborne diseases, such as SARS and COVID-19.

However, determining how to provide seamless orchestration between multiple robotic vendor platforms and heterogeneous robots for last mile delivery is a key challenge as different types of delivery robots and robotic vendors each come with their own capabilities. For example, small size land-robots focus on food or grocery delivery to curb side, doorstep or indoor office spaces, humanoid robots can be used to carry a delivery up and down steps, and in different terrains, but they are limited by their speed and carrying capacity, and autonomous vans concentrate on delivery to roadside. Therefore, to improve the efficiency of last-mile delivery process and handle different scenarios, heterogeneous delivery robots (having different operation characteristics) should be considered and the orchestration between them, to achieve a specific delivery task efficiently, must be solved. Furthermore, by using a cooperation strategy with multiple heterogeneous robots, contactless parcel delivery can be carried out within different environments whether they be indoor or outdoor or a combination of both, efficiently and safely.

Existing marketplace or e-commerce platforms can only orchestrate between vendors of a maximum of two categories of autonomous delivery robots. Existing platforms do not support integration with heterogeneous robots, orchestrate deliveries between multiple types of autonomous delivery robots nor can they transfer learning between swarm of heterogeneous robots. In addition, autonomous mobile robot vendors use their own custom Fleet Management software platform, which makes it difficult for end-users to operate and manage a swarm of mixed capability robots efficiently.

For example, US20180319014 A1 describes a system for performing an action with a robot. Implementations of the disclosure are directed to a robot orchestration architecture for a general-purpose robotics system that takes into account different inputs and enables actuation by a robot(s) based on those inputs in an intuitive, contextual fashion. However, this disclosure is limited to a single system and does not describe orchestrating multiple robotic platforms for delivery.

WO2017064202A1 describes a delivery method comprising communicating a request for a delivery from a delivery terminal to a server and/or to a robot and providing instructions from the server to the robot about the delivery. The instructions comprise information about the final delivery location, loading the robot with the delivery to be transported, transporting the delivery in the robot to the final delivery location, and providing access to the delivery in the robot, preferably upon arrival at the delivery location. This disclosure focuses on autonomous delivery methodology with a single type of robot and does not describe integrating autonomous delivery with heterogeneous robots.

Similarly, U.S. Pat. No. 10,459,450B2 describes a system for delivering an article from a first location to a second location with a robot having a closable transport container for housing the article during transport. A closable recipient container is provided at the second location for receiving the article. A computer configured to navigate the robot over an outdoor transportation network between locations is provided. The robot has a robot article transport mechanism controlled by the computer for removing the article from the transport container and the recipient container has a recipient article transport mechanism for moving the article inside the recipient container. However, this document does not address the issue of autonomous delivery with heterogeneous robots possibly over different platforms.

In a more complex manner, WO2017213621A1 describes a method for package delivery including identifying a plurality of delivery locations for package delivery. The method includes determining a driving route for an automated ground vehicle to optimise delivery to the delivery locations using one or more automated aerial vehicles, controlling the automated ground vehicle to navigate the delivery route, and determining timing for release of the one or more automated aerial vehicles during navigation of the delivery route to deliver packages to the plurality of delivery locations. This disclosure is limited to optimising delivery routes and maximising number of packages in a delivery run with vehicles and drones. There is no description of autonomous delivery with heterogeneous robots possibly over different platforms to optimise delivery efficiency.

US20180024554 A1 utilises autonomous ground vehicles (AGVs) to retrieve items from transportation vehicles for delivery to specified locations. In various implementations, the AGVs may be owned by individual users and/or may service a group of users in a given area. The AGVs may travel out to meet a transportation vehicle to receive items and may be joined by other AGVs that have travelled out to meet the transportation vehicle and may line up in a particular order. After the items are received, the AGVs may travel back to deliver the items, and may be equipped to open and close access barriers. However, this disclosure does not describe a method of controlling multiple heterogeneous robots from one or more control platforms and achieving optimised delivery allocation.

The present disclosure has been devised to address mitigate or overcome the above-mentioned limitations.

### SUMMARY OF DISCLOSURE

The present disclosure is directed to a delivery system for automatically delivering items from a source location to a destination location within a delivery environment, the system comprising: a plurality of remotely operable heterogeneous robots, and an orchestration system configured to control and orchestrate the plurality of heterogeneous robots to execute the delivery of items from the source location to the destination location. The orchestration system comprises an upstream communications engine, an orchestration logic engine, and a downstream communications engine. The delivery system of multiple types of robots as a smart logistics service reduces delivery cost, improves efficiency, and mitigates the risk of spreading airborne diseases.

The upstream communications engine communicates with a plurality of different service request platforms, the upstream communications engine being configured to receive a delivery request for the delivery and to transmit data relating to the status of the request as the request is processed.

The orchestration logic engine is configured to process the delivery request and select and instruct the plurality of heterogeneous robots to execute the delivery of the items from the source location to the destination location specified in the delivery request, each robot handling a unique part of the delivery and the concatenation of the unique parts forming the delivery from the source location to the destination location, the orchestration logic engine comprising a digital twin model for providing a 3D (3-Dimensional) map of the delivery environment in which the plurality of heterogeneous robots are operating, and being configured to constantly update the digital twin model with data received from the plurality of robots executing operations within the delivery environment. The 3D map enables a real-time picture of the environment in which the robot is travelling to be created and used to select and instruct a specific type of robot for a subsequent delivery task. This feedback from the sensors of the robots results in use of a regularly updated 3D map of the delivery environment being available to improve controlled movement of the robots which in turn minimises the amount of travel required by the robots to complete their task.

The downstream communications engine communicates with the plurality of heterogeneous robots either directly or via a plurality of different robotics control platforms each controlling a subset of the plurality of heterogeneous robots, the communications engine providing a communications gateway for receiving and transmitting data between the orchestration system and the plurality of heterogeneous robots, in use, the communications gateway being configured to convert messages between a first domain of the orchestration system and a different domain of each of the subsets of the plurality of heterogeneous robots to provide downstream interoperability. Interoperability enables seamless data exchange and communication between the orchestration system and the heterogeneous robots. This can help reduce the time and effort required to complete delivery tasks and enables a wider range of different robots to be available for assisting in part of the delivery.

The orchestration system may further comprise a data translation processor for converting the data carried by the messages from the plurality of robots into a singular specified format to enable consistent comparison and analysis of the data to provide upstream interoperability with any of the plurality of different service request platforms. As raw data is often difficult to analyse, transforming data in this way improves data quality and facilitates compatibility between the plurality of heterogeneous robots and the plurality of service request platforms.

The orchestration system may further comprise a persistence layer for storing information, the system being configured to receive robot capability and status information of the plurality of heterogeneous robots; to have the robot capability and status information translated by the data translation processor into the singular specified format and stored in the persistence layer. This layer is separate from the logic that serves as the foundation to the system and provides a consistent and reliable way to store and retrieve data that is not limited to a specific type of data source.

The orchestration logic engine may comprise a delivery eligibility model for determining the types of robots eligible to carry out any one of the unique parts of the delivery, the delivery eligibility model using the robot capability and status information provided by the persistence layer. By determining the eligible types of robots for the delivery task, the robots that are not suitable, perhaps due to their size or payload efficiency, can be removed from a selection pool, thereby increasing the efficiency of the robot selection process and the overall item delivery process.

The orchestration logic engine may be configured to send a message to the plurality of robots to call for an update of the robot status and capability information, in response to processing the delivery request and to determine up-to-date robot capability and status information received in response to the call. Advantageously, this enables the orchestration system to determine, at any time, the current availability status of the plurality of robots.

The orchestration logic engine may comprise a robot assignment model for assigning a most suitable robot for each unique part of the delivery, based upon the robot status and capability information, and to send an instruction selecting the most suitable robots for each part of the delivery. By assigning the most suitable robot for the delivery task, the time to taken to deliver the item is reduced. For example, if the delivery environment includes an alleyway, then a small appropriately sized robot will be assigned for the task as this type of robot can transverse through narrow spaces, rather than a large robot which would require an alternative possibly longer route to deliver the item, or in the worst case, may not be able to deliver the item at all.

The orchestration logic engine may be configured to determine each unique part of the delivery and to assign the most suitable robot to that part of the journey based on the factors of speed, payload efficiency, power consumption and/or robot recharging/refuelling factors.

The orchestration logic engine may comprise a ledger manager configured to save a list of the assigned most suitable robots for each unique part of the journey in a ledger and to assign a unique request identifier of the delivery request to the ledger. By saving a list of the most suitable robots, future robot selections for delivery can be provided more quickly than if the determination had to be made for each request.

The orchestration logic engine may be configured to update the status of the request to confirm selection of the robots and provide the status of the delivery request, via the upstream communications engine, to one of the plurality of service request platforms from which the delivery request was received. Keeping an up-to-date record of the status of the delivery request is beneficial as the service request platforms can perceive the estimated duration required to deliver each item, and whether the item has been delivered.

The robot capability and status information of the plurality of heterogeneous robots may comprise the current status of the robot including location, current payload, and range.

The communications gateway may comprise a plurality of different APIs (Application Programming Interfaces) each directed to a specific robot control platform. This feature also enables the delivery system to be compatible with many different types of robotics platforms and thus enables the orchestration system to be modular such that new robotics platforms can be accommodated by simply proving an API to the new robotics platform.

The orchestration logic engine may comprise a mapping data converter for converting different mapping coordinates from the plurality of heterogeneous robots into a singular specified mapping format for communications upstream to the different service request platforms. Converting different mapping coordinates allows for the integration of data from the plurality of heterogeneous robots as this integration ensures that all spatial data is compatible and can be used together.

The orchestration logic engine may comprise a robot validation and verification model for verifying an instruction to enable transfer of the items of the delivery from a first robot of the plurality of robots, which has completed the unique part of the delivery assigned to the first robot, to a second robot of the plurality of robots, which is about to commence a part of the delivery assigned to that second robot. This security measure ensures that the item has been transferred to the correct robot in the correct part of the delivery.

The orchestration logic engine may be configured to receive environment data from one or more of the plurality of robots and to broadcast the environment data to a plurality of other robots of the plurality of heterogeneous robots within the delivery environment. By broadcasting the environment data, a robot carrying out an assigned delivery receiving the broadcast can change their path if required, for example to avoid a hazard recently reported by another robot.

The orchestration logic engine may be configured to verify an instruction to enable transfer of the items of the delivery from a first robot of the plurality of robots, which has completed the unique part of the delivery assigned to the first robot, to a second robot of the plurality of robots, which is about to commence a part of the delivery, assigned to the second robot. By transferring the delivery task to another root, unnecessary energy consumption can be avoided as well as faster, more reliable, task completion.

According to another aspect of the present disclosure, there is provided a method of automatically delivering items from a source location to a destination location within a delivery environment, the method comprising: controlling and orchestrating a plurality of remotely-operable heterogeneous robots, using an orchestration system, to execute the delivery of items from the source location to the destination location, wherein the controlling and orchestrating step comprises: communicating upstream with a plurality of different service request platforms, the upstream communicating step including receiving a delivery request for the delivery and transmitting data relating to the status of the request as the request is processed; providing a digital twin model which includes a 3D (3-Dimensional) map of the delivery environment in which the plurality of heterogeneous robots are operating; updating the digital twin model with data received from the plurality of heterogeneous robots executing operations within the delivery environment; processing the delivery request and selecting and instructing the plurality of remotely-operable heterogeneous robots to execute the delivery of the items from the source location to the destination location specified in the delivery request, each robot handling a unique part of the delivery; concatenating the unique parts forming the delivery from the source location to the destination location; and communicating with a plurality of heterogeneous robots either directly or via a plurality of different robotics control platforms each controlling a subset of the plurality of heterogeneous robots, the downstream communicating downstream step providing a communications gateway for receiving and transmitting data between the orchestration system and the plurality of heterogeneous robots, and converting messages between a first domain of the orchestration system and a different domain of each of the subsets of the plurality of heterogeneous robots to provide downstream interoperability.

The present disclosure also extends to an orchestration system configured to control and orchestrate a plurality of remotely-operable heterogeneous robots to execute a delivery of items from a source location to a destination location within a delivery environment, the orchestration system comprising: an upstream communications engine for communication with a plurality of different service request platforms, the upstream communications engine being configured to receive a delivery request for the delivery and to transmit data relating to the status of the request as the request is processed; an orchestration logic engine configured to process the delivery request and select and instruct the plurality of remotely-operated heterogeneous robots to execute the delivery of the items from the source location to the destination location specified in the delivery request, each robot handling a unique part of the delivery and the concatenation of the unique parts forming the delivery from the source location to the destination location; and a downstream communications engine configured to communicate with the plurality of heterogeneous robots either directly or via a plurality of different robotics control platforms each controlling a subset of the plurality of heterogeneous robots, the communications engine providing a communications gateway for receiving and transmitting data between the orchestration system and the plurality of heterogeneous robots, in use, the communications gateway being configured to convert messages between a first domain of the orchestration system and a different domain of each of the subsets of the plurality of heterogeneous robots to provide downstream interoperability.

The orchestration system may further comprise a data translation processor for converting the data carried by the messages from the plurality of heterogeneous robots into a singular specified format to enable consistent comparison and analysis of the data to provide upstream interoperability with any of the plurality of different service request platforms.

The orchestration system may further comprise a persistence layer for storing information and the system may be configured to receive robot capability and status information of the plurality of heterogeneous robots; have the robot capability and status information translated by the data translation processor into the singular specified format and stored in the persistence layer.

In some embodiments, the orchestration logic engine comprises a delivery eligibility model for determining the types of robot eligible to carry out any one of the unique parts of the delivery, the delivery eligibility model using the robot capability and status information provided by the persistence layer.

The orchestration logic engine may be configured to send a message to the plurality of heterogeneous robots to call for an update of the robot status and capability information, in response to processing the delivery request and to determine up-to-date robot capability and status information received in response to the call.

The orchestration logic engine may comprise a robot assignment model for assigning a most suitable robot for each unique part of the delivery, based upon the robot status and capability information, and to send an instruction instructing selection of the most suitable robots for each part of the delivery.

The orchestration logic engine is, in some embodiments, configured to determine each unique part of the delivery and to assign the most suitable robot to that part of the journey based on the factors of speed, payload efficiency, power consumption and/or robot recharging/refuelling factors.

Preferably, the orchestration logic engine comprises a ledger manager configured to save a list of the assigned most suitable robot for each unique part of the journey in a ledger and to assign a unique request identifier of the delivery request to the ledger.

The orchestration logic engine may be configured to update the status of the request to confirm selection of the robots and provide the status of the delivery request, via the upstream communications engine, to one of the plurality of service request platforms from which the delivery request was received.

The robot capability and status information of the plurality of heterogeneous robots may in some embodiments, comprise the current status of each robot including location, current payload and range.

In an embodiment, the communications gateway comprises a plurality of different APIs (Application Programming Interfaces) each directed to a specific robot control platform.

The orchestration logic engine may comprise a mapping data convertor for converting different mapping coordinates from the plurality of heterogeneous robots into a singular specified mapping format for communications upstream to the different service request platforms.

The orchestration logic engine may comprise a robot validation and verification model for verifying an instruction to enable transfer of the items of the delivery from a first robot of the plurality of robots, which has completed the unique part of the delivery assigned to that first robot, to a second robot which is about to commence a part of the delivery assigned to that second robot.

In some embodiments, the orchestration logic engine comprises a digital twin model for providing a 3D (3-Dimensional) map of the delivery environment in which the plurality of heterogeneous robots is operating, the orchestration logic module being configured to constantly update the digital twin model with data received from the plurality of robots executing operations within the delivery environment.

The orchestration logic engine may be configured to receive environment data from one or more of the plurality of robots and to broadcast the environment data to a plurality of other robots of the plurality of heterogeneous robots within the environment.

The orchestration logic engine is configured, in some embodiments, to verify an instruction to enable transfer of the items of the delivery from a first robot of the plurality of robots, which has completed the unique part of the delivery assigned to the first robot, to a second robot of the plurality of robots, which is about to commence a part of the delivery, assigned to the second robot.

According to another aspect of the present disclosure there is provided a method of controlling and orchestrating heterogeneous robots to execute a delivery of items from a source location to a destination location within a delivery environment, the method comprising: communicating upstream with a plurality of different service request platforms, the upstream communicating step including receiving a delivery request for the delivery and transmitting data relating to the status of the request as it is processed; processing the delivery request and selecting and instructing a plurality of heterogeneous robot to execute the delivery of the items from the source location to the destination location specified in the delivery request, each robot handling a unique part of the delivery; and communicating downstream with a plurality of heterogeneous robots either directly or via a plurality of different robotics control platforms each controlling a plurality of robots, the downstream communicating step providing a communications gateway for receiving and transmitting data to and from the plurality of heterogeneous robots, and converting messages between a first domain of the orchestration system and a different domain of each of the subsets of the plurality of heterogeneous robots to provide downstream interoperability.

The embodiments of the present disclosure provide a scalable, open-source and cloud-agnostic delivery system that uses in one embodiment APIs for enabling communication between different robot control platforms. The present disclosure advantageously enables a wider selection of heterogeneous robots to be accessible to fulfil a delivery request as multiple different platforms and even autonomous robots can be access using the universal control domain that is created by the orchestration platform of the present embodiments.

The current disclosure focuses on how an intelligent supply chain platform provides a seamless and efficient orchestration between multiple kinds of autonomous robots to provide best in time delivery to the customers. The intelligent supply chain platform integrates with multiple robotic vendors' platform to orchestrate last mile delivery. The standardised communication and conversion layer securely connects with multiple robotic vendor's delivery platform on the downstream, to translate their messages and communication to a singular specified format for the consumption of upstream intelligent supply chain platform and orchestrate the last mile delivery process through the best possible robotic vendor depending on order type, size and availability of robots. The translated data exist in a standardised format, so that this data can be consumed by any other applications, e.g., TMS or other third-party vendors; which forms a cohesive communication channel in a multi-party scenario.

### BRIEF DESCRIPTIONS OF DRAWINGS

Specific embodiments of the disclosure will now be described, by way of example, with reference to the accompanying drawings of which:

FIG. 1 is a schematic block diagram showing a system according to an embodiment of the disclosure;

FIG. 2 is a schematic block diagram showing the details of the orchestration platform of FIG. 1;

FIG. 3 is a schematic block diagram showing the details of the orchestration logic engine of the orchestration platform of FIG. 2;

FIG. 4 is a schematic block diagram showing the details of the downstream communications engine of the orchestration platform of FIG. 2;

FIG. 5 is a flowchart of communication between the orchestration platform, intelligent supply chain platform and a robotics platform of the orchestration platform of FIG. 1;

FIG. 6 is a flowchart of the intelligent supply chain platform A of the system shown in FIG. 1;

FIG. 7 is a schematic block diagram showing the functional reference architecture of an orchestration platform of another embodiment of the present disclosure; and

FIG. 8 is a schematic block diagram showing the downstream communications engine and the persistence layer of the orchestration platform of FIG. 7 and how these elements cooperate with different robotics vendor platforms and heterogeneous individual robots.

### DETAILED DESCRIPTION OF EMBODIMENTS

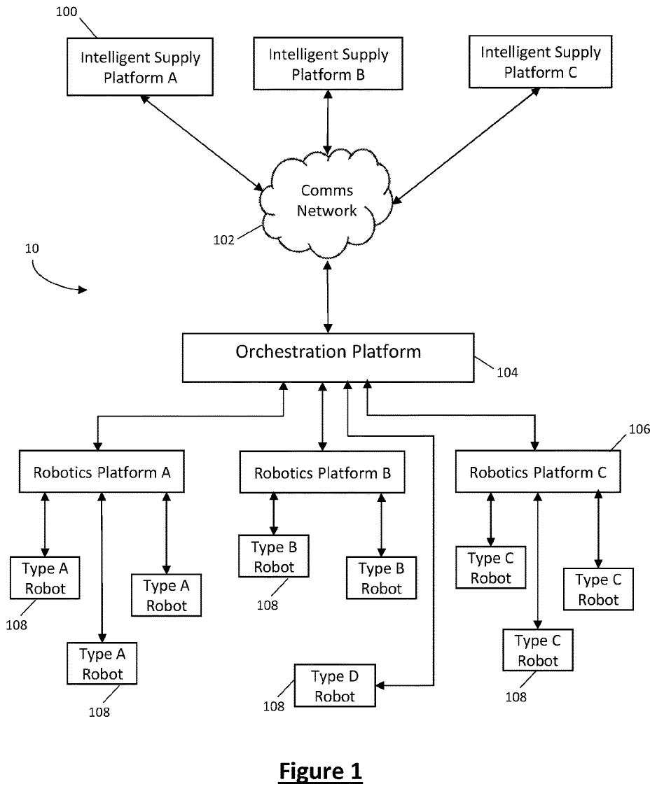

FIG. 1 shows the overview of an exemplary delivery system 10 for automatically delivering items from a source location to a destination location within a delivery environment. The delivery system 10 includes a plurality of remotely operable heterogeneous robots 108 and an orchestration platform 104 for controlling and orchestrating the plurality of heterogeneous robots to execute the delivery. The orchestration platform 104 cooperates with at least one upstream intelligent supply chain platform 100 (three shown in FIG. 1 though any number can be communicated with) and provides a seamless and efficient orchestration between multiple kind of autonomous robots to provide best-in-time, last mile delivery of items to customers. The orchestration platform 104 integrates with multiple robotics platforms 106 through use of a communications network 102 and securely connects with the robotics platforms 106 downstream of the orchestration platform 104. Autonomous robots 108 can communicate directly with the orchestration platform 104 if they do not have their own control platform.

The intelligent supply chain platform 100 provides a request for item transportation (delivery) task (robot booking) and the orchestration platform 104 determines what types of robots 108 are eligible for delivery. Based on this decision, an order booking request (selection instruction) is sent to the robotic platforms 106 via the orchestration platform 104 to determine the availability of the robots. Multiple robot vendor platforms 106 can respond to the orchestration platform 104 and can include information such as tracking (location) data and estimated time of delivery. The orchestration platform 104 translates messages from the domain of the robotic vendor platforms 106 into a singular specified format for the consumption by the intelligent supply chain platform 100 which has provided the request and for orchestration of the last mile delivery process through the best possible robotic vendor. The translated data exists in a standardised format, which advantageously allows this data to be consumed by other applications such as a TMS (Traffic Management System) or other third-party service provider platforms. This standardised format forms a cohesive communication channel in a multi-party scenario.

During the transportation of the order (items which are the subject of that order), the robotics platforms 106 share the associated tracking details for that order, which is translated and shared with the intelligent supply chain platform. When the order has reached its destination, the intelligent supply chain platform 100 marks the order as complete, and the robotics platform 106 updates the tracking details and marks the order as delivered.

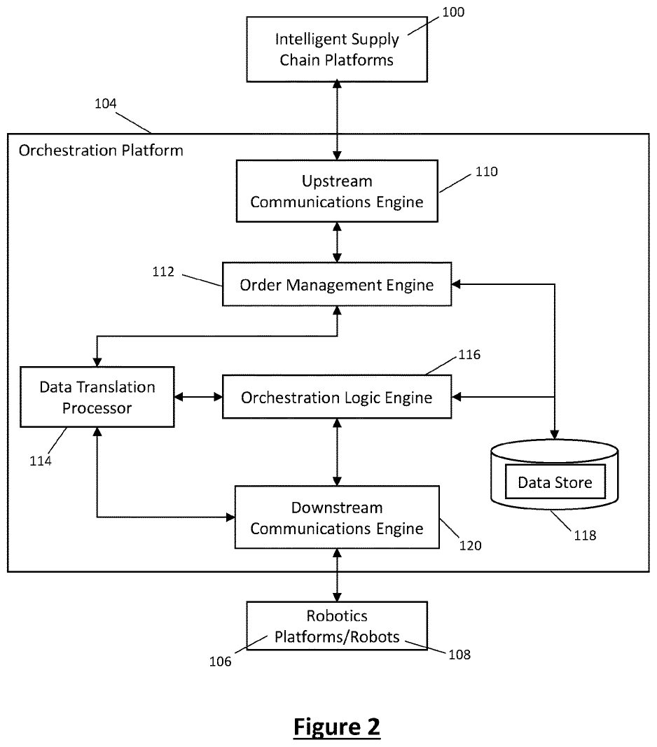

In FIG. 2, the orchestration platform 104 of the delivery system 10 is shown in greater detail. The orchestration platform 104 includes an upstream communication engine 110 that communicates with the intelligent supply chain platforms 100. The upstream communication engine 110 is a singular service that is called upon by the intelligent supply chain platform 100 to request robots 108 for orders, track in real time or cancel orders.

The upstream communication engine 110 also communicates with an order management engine 112. As communication methodology and structures vary from one robotics vendor platform 106 to another, the order management engine 112 is used to communicate with the upstream communication engine 110 and robotic platforms 106 by generating a unique ID, making it simpler for all the robotic platforms 106 to keep track of data based on a single unique ID. The unique ID is stored in a data store 118.

When the robot booking request is received from the intelligent supply chain platform 100, an orchestration logic engine 116 determines what types of robots 108 are eligible for delivery. Based on this decision, an order booking (selection) request is sent to the robotic platforms 106 via a downstream communications engine 120 to determine the availability of the robots 108. The downstream communications engine 120 is a secure communication channel between the upstream platform and downstream robotic vendors, leveraging API gateway, message hub, site to site VPN, mutual TLS, authentication through secured keys and encrypted messages.

Based on availability, the orchestration logical engine 116 then determines which robot 108 to assign to the delivery. Once chosen, responses received from the robotics platforms 106 are translated and shared with the intelligent supply chain platform 100. The orchestration logic engine 116 also communicates with the data store 118 and stores selected Vendor IDs for the order.

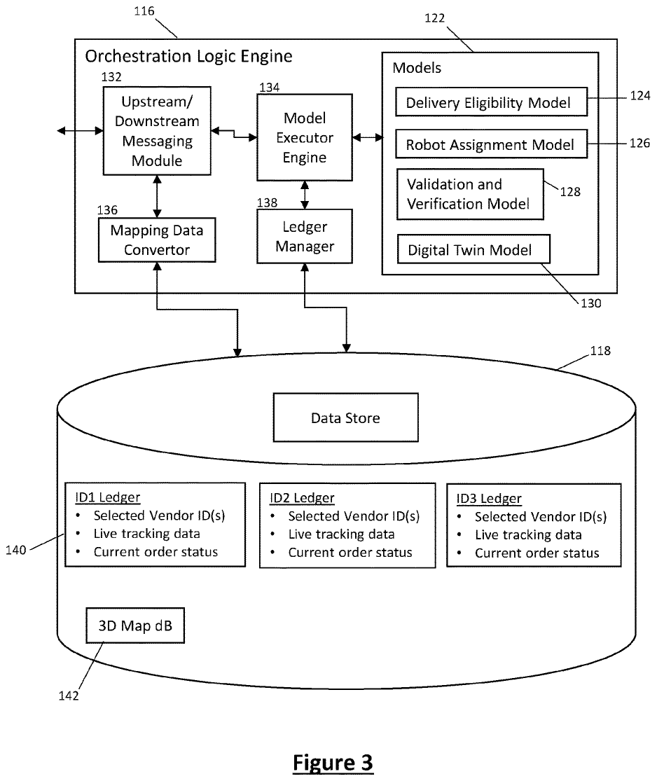

Referring to FIG. 3, the orchestration logic engine 116 of the delivery system 10 is shown in greater detail. The orchestration logic engine 116 has an upstream/downstream messaging module 132 which communicates with the intelligent supply chain platforms 100 via upstream messaging and communicates with the robotics platforms 106 via downstream messaging.

Based on the responses received from the upstream/downstream messaging module 132, a model executor engine 134 determines to which model 122 the responses should be provided. These models 122 run concurrently and provide different outputs based on their functionality. The models 122 include a delivery eligibility model 124, a robot assignment model 126, a validation and verification model 128 and a digital twin model 130.

The delivery eligibility model 124 determines which type of robot is eligible for delivery by taking into account data on the order details such as order volume, weight, item specific requirements, delivery location, distance, terrain, robotics platform's capability and traffic conditions as well as other parameters and matches them with a promised delivery time, capacity available, battery level, distance and other values to find the optimal robot selection through an algorithm (not shown) running on the model executor engine 134. The delivery eligibility model 124 also considers the type of delivery request made as well as any pre-determined parameters about the delivery and accordingly, can find a combination of multiple robotics platforms 106, and their specific robots 108, to be eligible to complete the delivery process. A pre-determined parameter can include environments with limited space, such as alleyways. If the delivery eligibility model 124 is aware of this environment, then a small robot that can transverse this space will be chosen for delivery. Furthermore, if a delivery is from a specific retailer to a customer's home at a medium distance, the delivery eligibility model 124 would determine that a land robot or a wheeled quadruped would be a best fit for this delivery. However, if there are multiple deliveries to an apartment building from an automated fulfilment centre, a combination of humanoid robots for picking and dropping and autonomous vans to transport the items are the best fit in this scenario. Moreover, if the delivery is an emergency request, such as for medicine, and traffic conditions are poor, then drones can be considered the best fit. Therefore, different scenarios based on the pre-defined parameters can invoke a different response from the delivery eligibility model 124 in the orchestration logic module and the orchestration platform 104 sends a service request to the appropriate robotics platform 106 accordingly.

The robot assignment model 126 determines the best possible robot to assign for delivery based on information such as the estimated time of delivery, the robot's battery capacity, distance to charging station, prioritised delivery request and the robot's payload capacity in order to optimise robot's performance, improve efficiency and provide best user experience. For example, if a robot is already on track to completing a delivery, the robot can also complete an additional delivery if the robot can fulfil the estimated time of delivery and has enough battery to complete both deliveries. In this way, the present disclosure is sustainable in its design, as one robot is used for multiple deliveries instead of multiple robots. However, for order consolidation that requires two vendors from two different locations, a small, but fast robot can deliver a first part of an order to a second vendor that has the remaining larger part of the order. A bigger robot can then deliver the order from the second vendor once the order has been consolidated.

The validation and verification model 128 verifies the upstream communication engine's 110 request to open and close the robot's door when the robot has reached the pick-up or delivery location in order to complete the delivery. Verification is carried out by checking that the positioning of the robot matches the order request position location before opening the robot's doors; if the robot position is equal to the expected position, then the robot is allowed to open its doors, otherwise the robot has to notify the customer and keep the doors locked. This verification module 128 also matches any incoming service request from the upstream communication engine 110 to the correct downstream communication engine 120 in addition to validating that the defined format is maintained in the request or the response from the upstream communications engine 110 or the downstream communications engine 120.

The digital twin model 130 takes in a 3D map of an area to provide a digital twin of the delivery environment in which the plurality of the heterogeneous robots is operating. The digital twin model is continuously updated from the data received from the robots executing operations within the delivery environment. This provides city planners with live updates and data to plan, design and implement infrastructure changes.

The model executor engine 134 also communicates with a ledger manager 138. The ledger manager 138 manages all the tracking information about the order from request to fulfilment and helps the orchestration platform 104 communicate this information to the correct robotics platform 106 by looking up stored values in the data store 118 after the order has been created against the selected vendor. The data store 118 stores a ledger database 140 in a persistence layer 224 for each vendor and contains information such as ledger store order ID, selected vendor ID for the order, time of delivery, live tracking data and current order status. This ledger database 140 then helps the orchestration platform 104 communicate to the correct robotics vendor platform 106. In addition, multiple vendor IDs can be added to the files making up the ledger database 140 for a particular order if multiple vendors are needed to fulfil the order.

During transportation, the robot's live tracking data and current order status information is translated and shared with the platforms for their consumption and live location mapping. A mapping data converter 136 in the orchestration logic engine 116 converts the mapping data into standardised GPS co-ordinate system through conversion and modification. For instance, some vendors may use data relative to another point and not absolute coordinates, and coordinates systems use multiple coordinates so there is a need to convert these points into in a single point. The mapping is hardcoded logic; the system is told what formula to use to convert the mapping data into the standardised GPS co-ordinate system. This provides the upstream communication engine 110 the capability to track multiple robots from different vendors in real time using a single map and co-ordinate system, which in-turn reduces complexity and provides better user experience. Moreover, the mapping data is communicated back to the robotics platforms 106, so multiple robot vendors can use the same mapping data and can be swarmed to different robots, which reduces effort to create new maps for a single delivery environment whenever a new vendor is introduced. The data store 118 stores a centralised mapping database 142 that includes live updates on traffic details, roadblocks and terrain changes which can be consumed by all the vendors in real time to update routes, mark no-go zones and optimise robot movement.

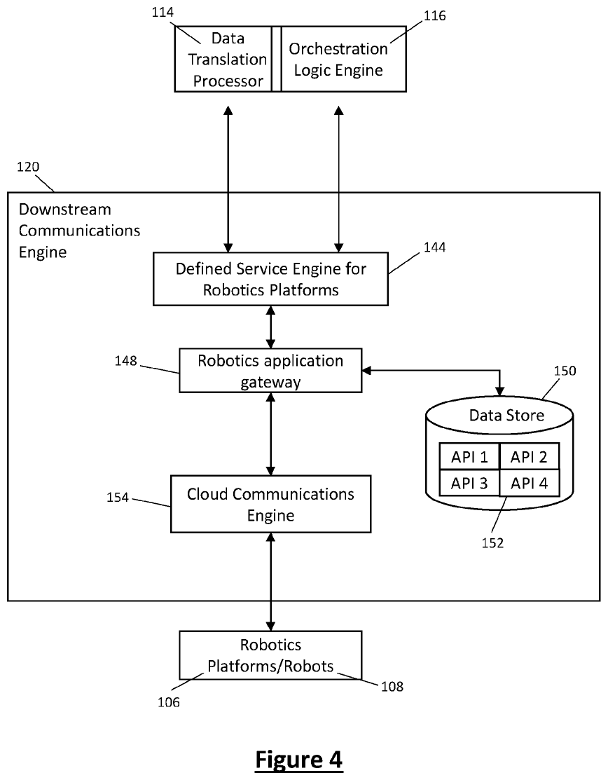

FIG. 4 shows the downstream communications engine 120 of the delivery system 10 in greater detail. The downstream communications engine 120 is the communication channel between the orchestration logic engine 116 and the robotics platforms 106 or autonomous robots 108.

Some communications between the orchestration logic engine 116 and the downstream communications engine 120 can be provided directly. Others need to be translated from the universal domain of the orchestration platform to the domain of the robot 108 or robotics platform 106. Messages translated via the data translation processor 114 and also direct messages are sent to a defined service engine for robotics platforms 144 requesting an appropriate robot for delivery. The defined service engine for robotics platform 144 implements a robotics application gateway 148 to enable interoperability between the universal domain of the orchestration platform 104 and the different domains of the robotics platforms 106. As part of the robotics application gateway 148, different predefined APIs 152 (Application Programming Interfaces) are provided in a local data store 150 which enable communication with the different robotics platforms 106 and robots 108. The APIs 152 are used to send the requests or receive the responses to or from the robotics platforms 106 via the cloud communications engine 154. The downstream communications engine 120 then asks the robotics platforms 106 or robots 108 themselves to respond to the robot requests and provide information such as capacity available in each robot and estimated time to destination.

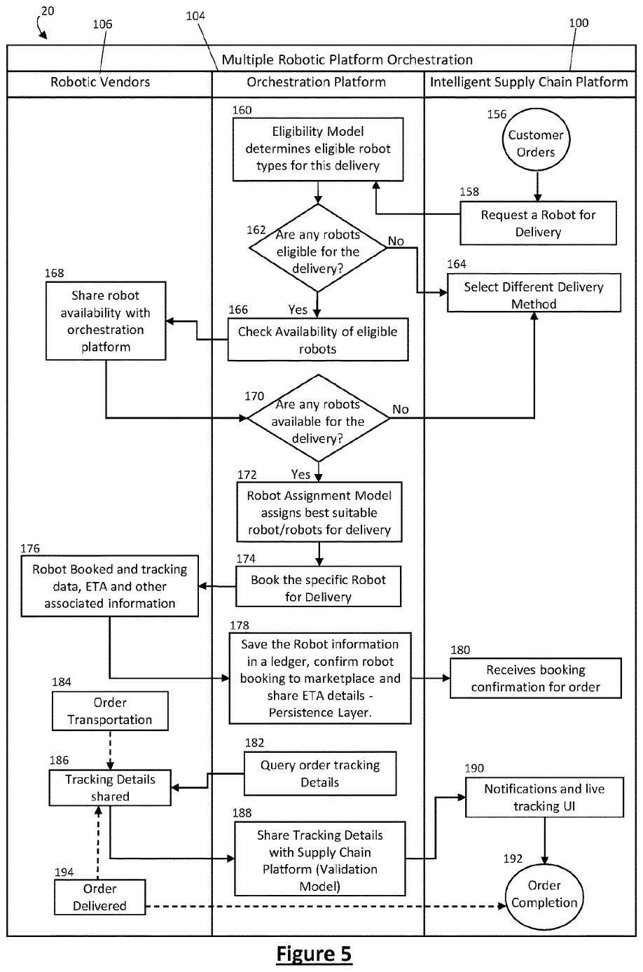

FIG. 5 shows a flowchart 20 describing the communication between the orchestration platform 104, intelligent supply chain platform 100 and robotics platforms 106 in an embodiment of the present disclosure. At block 156, the customer makes an order in the intelligent supply chain platform 100 and a request for a robot delivery is made to the orchestration platform 104 at block 158.

Once the orchestration platform 104 receives the request, the orchestration platform determines which type of robot is eligible for the delivery to be executed at block 160. This determination is based on order details such as order volume, weight, item specific requirements, delivery location, distance, terrain, robotic vendor's capability and traffic conditions. The delivery eligibility model 124 also considers the type of delivery request made as well as any pre-determined parameters about the delivery and even live environmental information about the delivery environment and accordingly, can find a combination of robots controlled by a plurality of robotic platforms 106 to be eligible to complete the delivery process.

Based on this decision, the orchestration platform 104 discerns whether there are any robots eligible for the delivery at block 162. If there are no robots that are eligible, then the orchestration platform 104 communicates to the intelligent supply platform 100 that a different delivery method must be selected at block 164. If there are robots eligible for delivery, the orchestration platform 104 checks the availability of the eligible robots at block 166. At block 168, the robotic vendors (robotics platforms 106) share their robots availabilities with the orchestration platform 104 and if any robots are available for delivery (block 170), then the robot assignment model 126 determines the best possible robot to assign for deliver at block 172. Otherwise, the orchestration platform 104 communicates to the intelligent supply platform 100 that a different delivery method must be selected at block 164.

The robot assignment model 126 then determines, at block 172, the best possible robot to assign for delivery and based on this decision, the orchestration platform 104 sends the order booking (selection) request to the robot robotic vendors 106 to determine availability of robots for this delivery at block 174. Multiple robot vendors can respond to the orchestration platform 104, at block 176, with a positive response to this request including tracking data, estimated time of delivery and any other associated information. Also, autonomous robots, which operate without the need for a platform, can receive and respond directly to such requests.

Once the robotic vendor confirms the assignment of the robot, the orchestration platform 104 stores the robot information into the ledger database 140 (namely within the ledger file under this unique task ID) in the data store 118 in the persistence layer 224, at block 178, confirms the booking (selection) to a marketplace (the appropriate intelligent supply platform 100) and shares the estimated time of delivery details, at block 180.

Aside from enabling interoperability between the orchestration platform 104 and the robotics platforms 106, the data translation processor 114 can convert information in any one of the different domains into the universal domain of the orchestration platform 104. For example GPS coordinates which are provided with reference to a given location can be translated into universal GPS coordinates. This information can then be shared with the relevant intelligent supply chain platform 100, confirming the delivery assignment using a universal location reference for example.

During the order transportation (block 184), the orchestration platform 104 queries the order tracking details with the robotic vendors at block 182 and the robotic vendors share the associated tracking details for that order at block 186. The robot's live tracking data and current order status information is translated and shared with the intelligent supply chain platform 100 at block 188. Notifications and live tracking are displayed on a user interface in the intelligent supply chain platform 100 at block 190.

When the order has reached its destination, the intelligent supply chain platform 100 marks the order as complete at block 192. The robotic vendor updates the tracking details (block 186) and also marks the order as delivered at block 194.

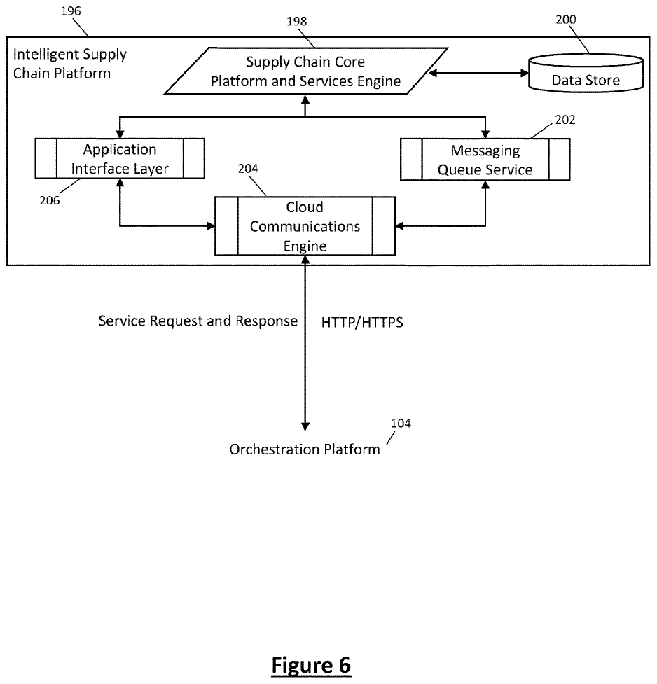

In FIG. 6, an example of an intelligent supply chain platform 196 is shown in detail. The intelligent supply chain platform 196, in this example, includes a supply chain core platform and services engine 198, which allows customers to connect to companies to deliver products. The supply chain core platform and services engine 198 collects and tracks information related to orders and stores the information in a local data store 200. The supply chain core platform and services engine 198 also sends requests to the orchestration platform 104. Each request initiates an application interface layer 206 to retrieve information via a cloud communications engine 204. For instance, the request for robots for delivery is communicated to the orchestration platform 104 via the cloud communications engine 204 and booking (selection) confirmation orders and order details are communicated back from the orchestration platform 104 via the cloud communications engine 204.

The messaging queue service 202 allows the application interface layer 206, the supply chain core platform and services engine 198, and the cloud communications engine 204 to exchange information by storing messages in the order they are transmitted until the consuming application can process them.

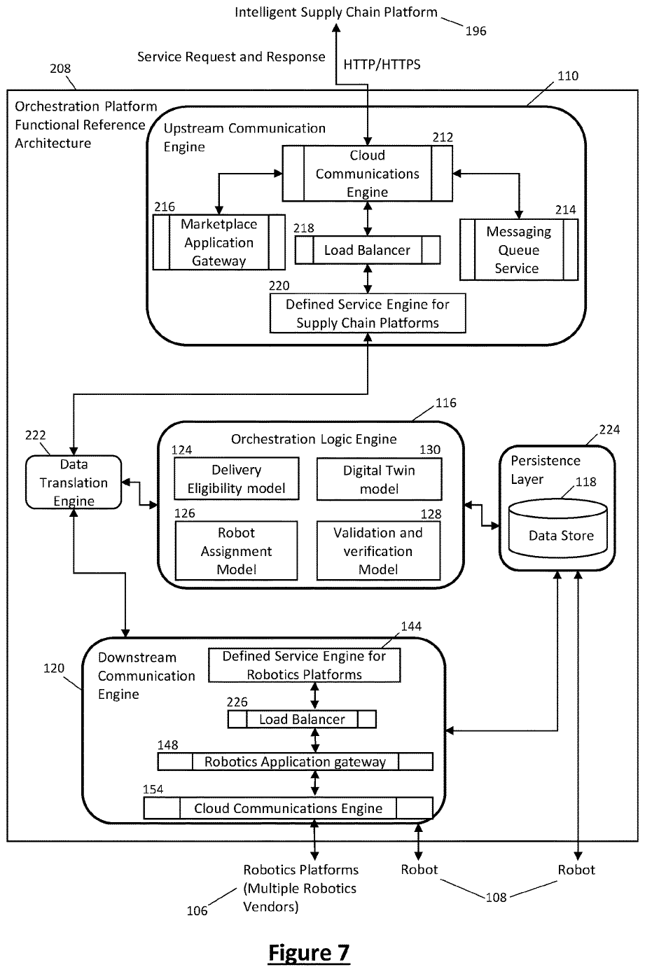

Referring to FIG. 7, the orchestration platform functional reference architecture 208 of another embodiment of the present disclosure is shown detail. This embodiment is very similar to the embodiment described earlier but is configured to operate with the specific intelligent supply platform 196 shown in FIG. 6. A cloud communications engine 212 in the upstream communication engine 110 of the orchestration platform 104 receives a request for robots for delivery via the cloud communications engine 212 of the intelligent supply chain platform 196 (shown in FIG. 6). The upstream communications engine 210 is also provided with a marketplace application gateway 216 which enables communication with existing marketplace or ecommerce platforms, and this also connects to the cloud communications engine 212 of the upstream communications engine 210. A messaging queue service 214 is provided as is a load balancer 218. Requests are sent to a defined service engine for supply chain platforms 220 requesting an appropriate robot for delivery. This message content is then translated at a data translation engine 222 into the standardised format, which allows the message content to be consumed by the orchestration logic engine 116 and the downstream communication engine 120.

The orchestration logic engine 116 of this embodiment works in the same manner as that described previously in the first embodiment. For instance, the orchestration logic engine 116 determines which type of robot is eligible for delivery in the delivery eligibility model 124, which robot is the best possible robot to assign for delivery in the robot assignment model 126 and verifies the upstream communication engine's 110 request to open and close the robot's door when the robot has reached the pick-up or delivery location in the validation and verification model 128. In addition, the orchestration logic engine 116 also provides the digital twin of the delivery environment in which the plurality of the heterogeneous robots are operating using the digital twin model 130.

As was described in the first embodiment, the orchestration platform 104 of this embodiment also creates the persistence layer 224 by setting up the ledger database 140 in the data store 118 which helps the orchestration platform 104 communicate to the correct vendor's platform 106 by looking up the stored values in the database 118 after an order has been created against the selected vendor. The persistence layer 224 is also in direct communication with the downstream communications engine 120 and the individual robots 108 as the persistence layer 224 relies on the cloud communications engine 212 and communication services for communication, respectively.

As was also described in the first embodiment, once the logic decisions have been made in the orchestration logic engine 116 in this embodiment, messages that need to be converted into a different domain are sent to the data translation engine 222 and translated to/from the standardised format. After the downstream communication engine 120 receives the translated messages via the defined service engine for robotics platform 144, load balancing techniques are used to handle multiple requests-response scenarios at once. The robotics application gateway 148 provides APIs for communication with the robotics platforms 106 and the APIs are then used to enable the sending of requests or receiving of the responses to or from the robotics platforms 106 via the cloud communications engine 154. Here, the messages are converted into the predefined appropriate formats by the appropriate APIs. The downstream communications engine 120 can also communicate with each robot 108 directly via a communication engine 236, 244, 252, 260, 268 in each robot.

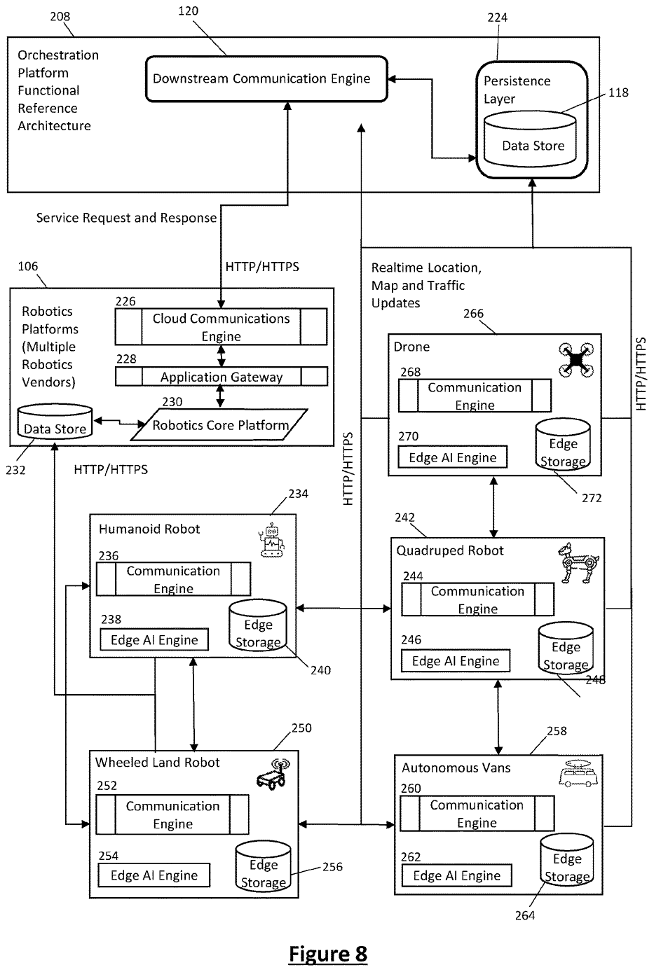

FIG. 8 shows the communication between the orchestration platform's downstream communication engine 120 and persistence layer 224 and the robotic platforms 106 and individual robots 234, 242, 250, 258, 266. An application gateway 228 in the robotics platforms 106 provides APIs for communication with the downstream communication engine 120 and the APIs are then used to send the requests or receive the responses to or from the downstream communication engine 120 via the cloud communications engine 226 of the robotics platform 106. The application gateway 228 also communicates with a robotic core platform 230 where tasks are specified for any type of robot and driver controls are carried out.

The robotics platforms 106 include a data store 232 of records concerning the individual robots 234, 242, 250, 258, 266 and these robots platforms can share the capabilities and status, such as availability of the robots 234, 242, 250, 258, 266 with the orchestration platform 104 via the cloud communications engine 228. Once the robot has been booked for delivery, the data store 232 is updated with details of the order, such as the type of robot requested, estimated time of delivery and tracking data. After the robot has completed the delivery, the tracking details are updated and shared with the orchestration platform 104 via the cloud communications engine 228. In addition, the robots 234, 242, 250, 258, 266 can communicate directly with the data store 232 of the robotics platforms 106 via the communication engine 236, 244, 252, 260, 268 in each robot 234, 242, 250, 258, 266, where the robot 234, 242, 250, 258, 266 can relay information related its location, battery status, and capacity. Furthermore, many robots have environmental sensors, such as cameras, and these robots can capture live information about their geographic location and provide that back to the robotics platform. This may be particularly useful where a robot is undertaking a part of a unique assigned delivery and an obstacle (such as a fallen tree, or obstructed entrance) blocks the delivery path. Knowledge of such an obstacle is relayed back to the orchestration platform 104 via the robotics platform 106 and can be useful in providing an up-to-date routing information regarding routes for subsequent deliveries which may also involve the location of the obstruction. In particular, this environmental feedback can update the 3D Map 142 of the delivery environment and is particularly advantageous in real-time (as the requests

Each robot 234, 242, 250, 258, 266, in this embodiment, also includes an edge artificial intelligence (AI) engine 238, 246, 254, 262, 270 and an edge storage data store 240, 248, 256, 264, 272. The edge AI engine 238, 246, 254, 262, 272 is a pretrained AI model which sits on the robot 234, 242, 250, 258, 266. Algorithms are processed locally on each robot 234, 242, 250, 258, 266 and data from edge AI does not need to be sent over a network for another platform to do the processing. This allows each robot 234, 242, 250, 258, 266 to process data and make decisions independently without a connection. In addition, edge AI uses less battery consumption than traditional AI models, allowing the robots to run for longer periods of time and eliminates the problem of storing large amounts of data to the cloud as the data collected is stored in the data store of the robot.

Further information regarding these embodiments is provided below.

The core functionalities of the orchestration platform 104 (or orchestration layer as it is referred to below) bear upon data stream conversion (converting between different data formats), data translation (altering the labels associated with particular data) and secure communication. Most of the robotic delivery vendors, provides an API endpoint to communicate with their platform to create, cancel or track order status for the deployed fleet of robot. However, these communication methodology and structures vary from one vendor's platform to another.

The present embodiments provide a unique and standardised methodology to communicate with the downstream vendors to achieve all the key functionalities required for automated order delivery. These embodiments leverage a unique ID: the “Order ID” created from an external platform or generated internally (by the order management engine), to communicate with the downstream vendor's platform, making it simpler for all the involved robotic platforms to keep track of the data based on a single unique ID.

The robotic delivery vendors mentioned herein refer to any platform capable of controlling robots to provide autonomous or semi-autonomous delivery, including but not limited to platforms controlling autonomous land robots, autonomous vans, humanoid robots, quadruped robots or drones.

The orchestration layer 104, in addition creates a persistence layer 224 within the layer by setting up a ledger database 140 against each unique order ID and adding the selected vendor ID or multiple selected vendor IDs (if multiple vendors are being used) for the order. The database 140 is made up of records which each keep all tracking information about that order from request to fulfilment and is updated from the robotics platforms/robots themselves. The ledger database 140 then helps the orchestration layer 104 communicate to the correct vendor's platform, by looking up the stored values in the database 104 after an order has been created against the selected vendor. These stored values are typically variable parameters of the retailer's storage such as order ID, vendor ID, promised time for delivery, and other order specific information. This can be considered to be inventory management using APIs.

The upstream communication with the supply chain platform 100 or to other applications, e.g., TMS can happen and is also standardised. This methodology designed for the upstream side is very similar to that of the robotic vendors', but with some changes in data parameters, such as capacity available for each robot and time to destination. This is a singular service that is called upon by the supply chain platform 100 to book robots for the orders, track the orders in real time or to cancel orders.

The orchestration layer 104 does the job of handling the request for a specific task, calling the right service nodes on the robotics vendor side, collecting the data, translating the messages (here the translation is to create consistency between the data which has been obtained), and communicating back to the intelligent supply chain platform with a response. For the service requests, the orchestration layer uses load balancing techniques to handle multiple requests-response scenarios at once.

The orchestration layer 104, creates a secure communication channel between the upstream platform and downstream robotic vendors, leveraging API gateways, message hub, site to site VPN, mutual TLS, authentication through secured keys and encrypted messages.

The orchestration layer 104 standardises the mapping information of the site. Currently, different robotic vendors provide separate mapping data and follow their own co-ordinate systems. The orchestration layer 104 provides a methodology to convert the mapping data of different coordinate systems into a standardised GPS co-ordinate like system through conversion and modification. This is hard coded into logic which has been previously determined. This provides the upstream side the capability to track multiple robots from different vendors in real time, using a single map and co-ordinate system, which in-turn advantageously reduces complexity, reduces errors and provides a better user experience.

Moreover, multiple robot vendors can use the same mapping data that has been created by the orchestration layer 104, which reduces effort to create new maps for a single delivery environment whenever a new vendor comes in. In this case, the contents of the 3D Map Database 142 can be swarmed to different robots and platforms to update them with the latest information. The centralized mapping database 142 also includes live updates on traffic details, roadblocks and terrain changes which can be consumed by all the vendors in real time to update routes, mark no-go zones and optimize robot movement.

Additionally, this 3D map of the delivery environment, can be fed into live digital twin models 130, which is always updated, from the received data of the robots. This digital twin of the delivery environment provides a 3D map to other platforms and software tools for their potential use. For example, the digital twin model can be provided to city planners with live updates and data to plan, design and implement infrastructure changes.

When the orchestration layer 104 receives a robot booking (selection) request from upstream supply chain platform 100, the orchestration layer determines which types of robot are eligible for the delivery to be executed. The orchestration logic module 116 runs a delivery eligibility model 124, which takes into account data on the order details (package volume, weight and type of items), possible routes delivery location, terrain information, and robotic vendor's capability. For example, the model ingests, total weight, package volume and numbers, delivery location, inventory locations and other parameters and matches them with promised delivery time, capacity available, battery parameters, distance and other values to find the optimal decision regarding delivery.

The delivery eligibility model 124 also considers the type of delivery request been made; and accordingly, might find a combination of multiple platforms to be eligible to complete the delivery process. For example, if a delivery is to happen from a specific retailer shop to the customer's home at a medium distance; the delivery eligibility model 124 would determine that a land robot or a wheeled quadruped is a best fit to this delivery. However, if there are multiple deliveries to an apartment building from an automated fulfillment centre, a combination of humanoid robots for picking and dropping and an autonomous van to transport the items are best fit in this scenario. If a delivery is an emergency request for a medicine, then drones might be considered the best fit depending on traffic conditions or live feedback data from the robots regarding obstacles. So different scenarios based on the pre-defined parameters would invoke a different response from the delivery eligibility model in the orchestration logic module and the orchestration layer would send a service request to the appropriate robotics platform accordingly. For example, if it is known that the robot will have to pass through a very narrow space, knowledge of the robot's dimensions enables an appropriately sized robot to be selected for delivery to avoid the robot getting stuck in the narrow space. Similarly, if the robots provide status information about their environment back to the orchestration logic engine to update the 3D map 142 and the digital twin model 130, then this can be used to select the appropriate robot for the delivery or part of the delivery.

Based on this decision, the orchestration layer 104 sends an order booking (selection) request to the downstream robot platforms 106, for availability of robots for this delivery. Multiple robot platforms 106 may respond with a positive response to this request with probable ETA (estimated time of arrival) for delivery.

The orchestration layer 104 then determines the best possible robot to assign for this delivery and request the selected robotic platform to assign a robot. This decision is based on the robot assignment model 126 in the orchestration logic module 116 which takes into account ETA of delivery, robots' battery capacity, distance to charging station, prioritized delivery request and robot's payload capacity; in order to optimize robot's performance, improve efficiency and provide best user experience. An example of this is seen when there is a robot on the road finishing a delivery and a new empty robot available to take a new delivery task. It may seem natural to choose the empty robot, but the robot assignment model 126 understands that the robot already running can in this case meet the specified ETA in time and have enough battery power to fulfil both shipments leaving the standby robot available for a longer journey. This would also then only require one robot to be recharged rather than two which may be an issue if the number of electrical charging points for robots is limited or in high demand.

An example of a multi-part journey instead can be order consolidation as determined by the robot assignment model 126. Assume an order requires two vendors from two different locations. The robot assignment model 126 can determine that a small, fast robot deliver the first part of the order from the first vendor to the second vendor that has the rest of the bigger order. Then another bigger robot can deliver the second part of the order after consolidation with the first part.

When the robotics platform 106 confirms the assignment of the robot, the orchestration layer 104 translates the message received from the robotics vendor and shares with the upstream supply chain platform confirming the delivery assignment. Examples of the data that is translated include location, order status, time to arrive and charging status. During the transportation, the robot's live tracking data and current order status information is translated and shared with the platforms such a marketplace or the intelligent supply platforms 100 for their consumption and live location mapping.

The orchestration logic module 116 also runs a verification model 128 which verifies the upstream layer's request to open and close robot door, when the robot has reached pick-up or delivery location; to complete the delivery. This would simply be a comparison of whether the current robot position=expected robot position and if it were the door would open, if not, the door on the delivery robot would stay shut preventing access to the items to be delivered. This verification module 128 also matches any incoming service request from upstream layer to the correct downstream layer, in addition to validating the defined format is maintained in request or response from upstream or downstream layer.

Turning now to other embodiments, it will be appreciated that the method 20 may be embodied in a computer program. For example, a computer program product may comprise a computer readable medium, the computer readable medium having computer readable code embodied thereon. The computer readable code can be configured such that, on execution by a suitable computer or processor, the computer or processor is caused to perform the method or methods described herein (such as the method 20).

A computer program may take different forms, for example, source code, compiled code, executable code, or any other type of code. It will be appreciated that the source code of computer programs may be written in a wide variety of different programming languages, and may take different architectural designs. For example, the functionality described herein may be split across various different sub-routines. Furthermore, the skilled person will appreciate that many different ways of splitting the functionality between the different sub-routines will be possible. The sub-routines may be stored together in one executable file to form a self-contained program. Furthermore, computer programs may call external and/or standard libraries of computer code for performing certain sub-tasks associated with the functionality described herein.

In another embodiment, there is a computer program product comprising non-transitory computer readable media, having stored thereon a computer program as described above. Examples of computer readable media include, but are not limited to: ROM, such as a CD ROM, a semi-conductor ROM or a magnetic recording medium such as a hard disk.

In another embodiment, there is a carrier containing a computer program. Examples of carriers include but are not limited to an electronic signal, optical signal, radio signal, computer storage medium, or similar. The carrier of a computer program may be any entity or device (e.g. hardware) capable of carrying the program. As an example, a carrier may be a computer readable media as described above. In other examples a carrier may be a transmissible carrier such as an electronic or optical signal, which may be conveyed via electrical or optical cable or by radio or other means.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these claims cannot be used to advantage. Any reference signs in the claims should not be construed as limiting the scope. Furthermore, it will be understood that features, advantages, and functionality of the different embodiments described herein may be combined without departing from the spirit or scope of the disclosure herein.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A delivery system for automatically delivering items from a source location to a destination location within a delivery environment, the delivery system comprising:
a plurality of remotely operable heterogeneous robots, and
an orchestration system configured to control and orchestrate the plurality of heterogeneous robots to execute a delivery of items from the source location to the destination location, the orchestration system comprising:
an upstream communications engine for communication with a plurality of different service request platforms, the upstream communications engine being configured to receive a delivery request for the delivery and to transmit data relating to status of the request as the request is processed;
an orchestration logic engine configured to process the delivery request and select and instruct the plurality of heterogeneous robots to execute the delivery of the items from the source location to the destination location specified in the delivery request, each robot handling a unique part of the delivery and concatenation of the unique parts forming the delivery from the source location to the destination location, the orchestration logic engine comprising a digital twin model for providing a 3D (3-Dimensional) map of the delivery environment in which the plurality of heterogeneous robots are operating, and being configured to constantly update the digital twin model with data received from the plurality of robots executing operations within the delivery environment; and
a downstream communications engine for communicating with the plurality of heterogeneous robots either directly or via a plurality of different robotics control platforms each controlling a subset of the plurality of heterogeneous robots, the downstream communications engine providing a communications gateway for receiving and transmitting data between the orchestration system and the plurality of heterogeneous robots, in use, the communications gateway being configured to convert messages between a first domain of the orchestration system and a different domain of each of the subsets of the plurality of heterogeneous robots to provide downstream interoperability.

2. The delivery system of claim 1, wherein the orchestration system further comprises a data translation processor for converting the data carried by the messages from the plurality of robots into a singular specified format to enable consistent comparison and analysis of the data to provide upstream interoperability with any of the plurality of different service request platforms.

3. The delivery system of claim 2, wherein the orchestration system further comprises a persistence layer for storing information, the system being configured to receive robot capability and status information of the plurality of heterogeneous robots; to have the robot capability and status information translated by the data translation processor into the singular specified format and stored in the persistence layer.

4. The delivery system of claim 3, wherein the orchestration logic engine comprises a delivery eligibility model for determining types of robots eligible to carry out any one of the unique parts of the delivery, the delivery eligibility model using the robot capability and status information provided by the persistence layer.

5. The delivery system of claim 4, wherein the orchestration logic engine is configured to send a message to the plurality of heterogeneous robots to call for an update of the robot status and capability information, in response to processing the delivery request and to determine up-to-date robot capability and status information received in response to the call.

6. The delivery system of claim 3, wherein the orchestration logic engine comprises a robot assignment model for assigning a most suitable robot for each unique part of the delivery, based upon the robot status and capability information, and to send an instruction selecting the most suitable robots for each part of the delivery.

7. The delivery system of claim 6, wherein the orchestration logic engine is configured to determine each unique part of the delivery and to assign the most suitable robot to that part of the delivery based on factors of speed, payload efficiency, power consumption and/or robot recharging/refuelling factors.

8. The delivery system of claim 6, wherein the orchestration logic engine comprises a ledger manager configured to save a list of the assigned most suitable robot for each unique part of the delivery in a ledger and to assign a unique request identifier of the delivery request to the ledger.

9. The delivery system of claim 6, wherein the orchestration logic engine is configured to update the status of the request to confirm selection of the plurality of heterogeneous robots and provide the status of the delivery request, via the upstream communications engine, to one of the plurality of service request platforms from which the delivery request was received.

10. The delivery system of claim 3, wherein the robot capability and status information of the plurality of heterogeneous robots comprises current status of each robot including location, current payload, and range.

11. The delivery system of claim 1, wherein the communications gateway comprises a plurality of different APIs (Application Programming Interfaces) each directed to a specific robot control platform.

12. The delivery system of claim 1, wherein the orchestration logic engine comprises a mapping data converter for converting different mapping coordinates from the plurality of heterogeneous robots into a singular specified mapping format for communications upstream to the different service request platforms.

13. The delivery system of claim 1, wherein the orchestration logic engine comprises a robot validation and verification model for verifying an instruction to enable transfer of the items of the delivery from a first robot of the plurality of robots, which has completed the unique part of the delivery assigned to that first robot, to a second robot which is about to commence a part of the delivery assigned to that second robot.

14. The delivery system of claim 1, wherein the orchestration logic engine is configured to receive environment data from one or more of the plurality of robots and to broadcast the environment data to a plurality of other robots of the plurality of heterogeneous robots within the delivery environment.

15. The delivery system of claim 1, wherein the orchestration logic engine is configured to verify an instruction to enable transfer of the items of the delivery from a first robot of the plurality of robots, which has completed the unique part of the delivery assigned to the first robot, to a second robot of the plurality of robots, which is about to commence a part of the delivery, assigned to the second robot.

16. A method of automatically delivering items from a source location to a destination location within a delivery environment, the method comprising:
controlling and orchestrating a plurality of remotely operable heterogeneous robots, using an orchestration system, to execute a delivery of items from the source location to the destination location, wherein the controlling and orchestrating step comprises:
communicating upstream with a plurality of different service request platforms, the upstream communicating step including receiving a delivery request for the delivery and transmitting data relating to status of the request as the request is processed;
providing a digital twin model which includes a 3D (3-Dimensional) map of the delivery environment in which the plurality of heterogeneous robots is operating;
updating the digital twin model with data received from the plurality of heterogeneous robots executing operations within the delivery environment;
processing the delivery request and selecting and instructing the plurality of remotely operable heterogeneous robots to execute the delivery of the items from the source location to the destination location specified in the delivery request, each robot handling a unique part of the delivery;
concatenating the unique parts forming the delivery from the source location to the destination location; and
communicating downstream with a plurality of heterogeneous robots either directly or via a plurality of different robotics control platforms each controlling a subset of the plurality of heterogeneous robots, the downstream communicating step providing a communications gateway for receiving and transmitting data between the orchestration system and the plurality of heterogeneous robots, and converting messages between a first domain of the orchestration system and a different domain of each of the of the subsets of the plurality of heterogeneous robots to provide downstream interoperability.

17. An orchestration system configured to control and orchestrate a plurality of remotely operable heterogeneous robots to execute a delivery of items from a source location to a destination location within a delivery environment, the orchestration system comprising:
an upstream communications engine for communication with a plurality of different service request platforms, the upstream communications engine being configured to receive a delivery request for the delivery and to transmit data relating to status of the request as the request is processed;
an orchestration logic engine configured to process the delivery request and select and instruct the plurality of remotely operated heterogeneous robots to execute the delivery of the items from the source location to the destination location specified in the delivery request, each robot handling a unique part of the delivery and the concatenation of the unique parts forming the delivery from the source location to the destination location; and
a downstream communications engine configured to communicate with the plurality of heterogeneous robots either directly or via a plurality of different robotics control platforms each controlling a subset of the plurality of heterogeneous robots, the downstream communications engine providing a communications gateway for receiving and transmitting data between the orchestration system and the plurality of heterogeneous robots, in use, the communications gateway being configured to convert messages between a first domain of the orchestration system and a different domain of each of the subsets of the plurality of heterogeneous robots to provide downstream interoperability.

18. The orchestration system of claim 17, further comprising a data translation processor for converting the data carried by the messages from the plurality of heterogeneous robots into a singular specified format to enable consistent comparison and analysis of the data to provide upstream interoperability with any of the plurality of different service request platforms.

19. The orchestration system of claim 18, further comprising a persistence layer for storing information, the system being configured to receive robot capability and status information of the plurality of heterogeneous robots; to have the robot capability and status information translated by the data translation processor into the singular specified format and stored in the persistence layer.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. A method of controlling and orchestrating heterogeneous robots to execute a delivery of items from a source location to a destination location within a delivery environment, the method comprising:
communicating upstream with a plurality of different service request platforms, the upstream communicating step including receiving a delivery request for the delivery and transmitting data relating to status of the request as it is processed;
processing the delivery request and selecting and instructing a plurality of heterogeneous robots to execute the delivery of the items from the source location to the destination location specified in the delivery request, each robot handling a unique part of the delivery; and
communicating downstream with a plurality of heterogeneous robots either directly or via a plurality of different robotics control platforms each controlling a plurality of robots, the downstream communicating step providing a communications gateway for receiving and transmitting data to and from the plurality of heterogeneous robots, and converting messages between a first domain of the orchestration system and a different domain of each of the subsets of the plurality of heterogeneous robots to provide downstream interoperability.
